(19) United States
(12) Patent Application Publication
(10) Pub. No.: US 2011/0238693 A1
(43) Pub. Date: Sep. 29, 2011

(54) APPARATUS AND METHOD FOR SEARCHING IN MOBILE TERMINAL BY USING ONTOLOGY DATABASE

(75) Inventors: Jeong-Mi Seok, Suwon-si (KR); Jin-Woo Jeon, Suwon-si (KR); Young-Jip Kim, Suwon-si (KR); Joon-Ho Park, Hwaseong-si (KR)

(73) Assignee: SAMSUNG ELECTRONICS CO., LTD., Suwon-si (KR)

(21) Appl. No.: 13/070,316

(22) Filed: Mar. 23, 2011

(30) Foreign Application Priority Data
Mar. 23, 2010 (KR) 10-2010-0025582

(51) Int. Cl. G06F 17/30

(52) U.S. Cl. 707/769; 707/E17.099

(57) ABSTRACT

An apparatus and method search for data in a mobile terminal by using an ontology database. A function and data of the mobile terminal are managed in an ontology database. A keyword is received through a search function. Using the ontology database, one or more data related to the inputted keyword is searched. And the searched data is displayed.

### CROSS-REFERENCE TO RELATED APPLICATION(S) AND CLAIM OF PRIORITY

The present application claims priority under 35 U.S.C. §119 to an application filed in the Korean Intellectual Property Office on Mar. 23, 2010 and assigned Serial No. 2010-0025582, the contents of which are incorporated herein by reference.

### TECHNICAL HELD OF THE INVENTION

The present invention relates generally to an apparatus and method for searching data in a mobile terminal and, in particular, to an apparatus and method for searching data in a mobile terminal by using an ontology database.

### BACKGROUND OF THE INVENTION

The term “ontology” means components (concepts) of the contents managed by a system and their inter-relationships in artificial intelligence or Web-related research. That is, the term “ontology” basically refers to concept definition and generally means computer-readable formal definition representing a term and the relationship between terms.

Ontology is formal and explicit specification about shared conceptualization. Ontology may be considered as a type of dictionary containing words and relationships, in which words related to subjects and the relationships between words are represented hierarchically, and inference rules capable of extending the relationships between words or concepts and the hierarchy thereof are included, thus enabling Web-based knowledge processing, knowledge sharing between application programs, and knowledge reuse.

The use of mobile terminals is rapidly increasing due to their portability, and service providers (terminal manufacturers) are competitively developing mobile terminals with convenient functions in order to attract more users. For example, the mobile terminals provide various functions such as phone book, game, scheduler, short message, Internet, e-mail, alarm, MP3 (MPEG Audio Layer-3), digital camera, and electronic dictionary.

Recently, in order to enable users to use such various functions more simply and conveniently, mobile terminals iconize some functions as widgets. The user may arrange widgets of a mobile terminal on a window screen of the mobile terminal according to his tastes and may select one of the widgets to directly access the corresponding function.

However, because the mobile terminal provides only some functions in the shape of a widget, the user may select and use only widgets included in a widget list of the mobile terminal. Thus, there is a limitation in providing all of the various functions of an evolving mobile terminal in the shape of a widget.

The widget provides a shortcut to an application that enables the user to access a desired function directly without passing through a menu tree. However, the widget may not provide a free access to various functions of an evolving mobile terminal or to data stored in the mobile terminal. Accordingly, in order to access data in the mobile terminal, the user must perform several selection operations to access an application storing the data, and must perform a search operation in the application.

### SUMMARY OF THE INVENTION

To address the above-discussed deficiencies of the prior art, it is a primary aspect of the present invention is to substantially solve at least the above problems and/or disadvantages and to provide at least the advantages below. Accordingly, an object of the present invention is to provide an apparatus and method for searching data in a mobile terminal by using an ontology database.

Another object of the present invention is to provide an apparatus and method for managing all functions and data in a mobile terminal by using an ontology database.

Another object of the present invention is to provide an apparatus and method for directly accessing user's desired data without the use of an application, by searching all keyword-related data regardless of the types of applications and data in a mobile terminal by using an ontology database.

Another object of the present invention is to provide an apparatus and method for executing a function and data using one touch by representing functions as well as data stored in a mobile terminal in the shape of a widget, by using each of data in an ontology database as a widget item.

Another object of the present invention is to provide an apparatus and method for searching other functions or data in a mobile terminal among all the functions and data by using an ontology database and supporting a connection to the searched functions and data.

According to an aspect of the present invention, a method for searching data in a mobile terminal is provided. A function and data of the mobile terminal are managed in an ontology database. A keyword is received through a search function. Using the ontology database, one or more data related to the inputted keyword is searched. And the searched data is displayed.

According to another aspect of the present invention, an apparatus for searching data in a mobile terminal is provided. The apparatus includes a memory unit, an input unit, a control unit, and a display unit. The memory unit manages a function and data of the mobile terminal in an ontology database. The input unit receives a keyword input through a search function. The control unit searches one or more data related to the inputted keyword using the ontology database. And the display unit displays the searched data.

According to yet another aspect of the present invention, an apparatus for searching data in a mobile terminal is provided. The apparatus includes a memory unit and a control unit. The memory unit manages functions and data of the mobile terminal in an ontology database and stores a program for searching data using the ontology database. The control unit executes the program to search the ontology database for at least one of a function and data related to a keyword received from an input unit and returns at least one of a searched function and data.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a mobile terminal according to an embodiment of the present invention;

FIG. 2 illustrates a process for searching data in a mobile terminal by using an ontology database according to an embodiment of the present invention;

FIGS. 3A-3C illustrate an example of searching data in a mobile terminal by using an ontology database according to an embodiment of the present invention;

FIG. 4 illustrates an example of registering a function or data as a widget in a mobile terminal in its execution state according to an embodiment of the present invention; and

FIGS. 5A-5D illustrate an example of supporting a connection from a function or data to another function or data in a mobile terminal through a search function according to an embodiment of the present invention.

### DETAILED DESCRIPTION OF THE INVENTION

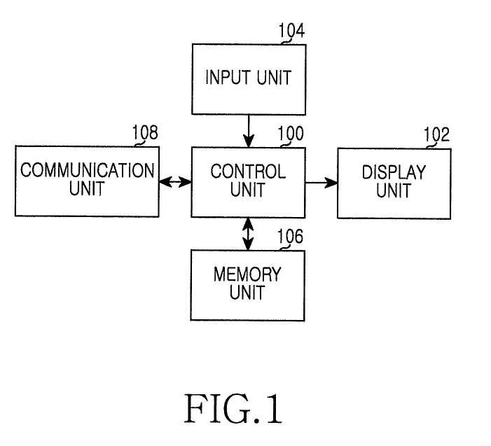

FIGS. 1 through 5D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication terminal.

The present invention provides a scheme for searching data in a mobile terminal by using an ontology database.

FIG. 1 is a block diagram of a mobile terminal according to an embodiment of the present invention.

Referring to FIG. 1, the mobile terminal includes a control unit 100, a display unit 102, an input unit 104, a memory unit 106, and a communication unit 108.

The control unit 100 processes and controls an overall operation of the mobile terminal. For example, the control unit 100 processes and controls voice communication and data communication. In addition to the general functions, the control unit 100, according to an embodiment of the present invention, uses an ontology database to search data. That is, the control unit 100 manages all functions and data of the mobile terminal in an ontology database and uses the ontology database to search all keyword-related data regardless of the types of applications or data. Also, the control unit 100 uses each of the data in the ontology database as a widget item, uses the ontology database to search other functions or data among all the functions or data in the mobile terminal, and supports a connection to the searched functions or data.

The display unit 102 displays numerals and characters, moving pictures, still pictures and status information generated during an operation of the mobile terminal. The display unit 102 may be implemented using a color liquid crystal display (LCD). The input unit 104 includes a plurality of numeric keys and a plurality of function keys. The input unit 104 provides the control unit 100 with key input data corresponding to a key pressed by a user. Herein, the functions of the display unit 102 and the input unit 104 may be performed by a touchscreen unit (not illustrated) that provides a touch screen input through a screen touch of the user and a graphic screen display through a touchscreen.

The memory unit 106 stores various data and programs that are necessary for an overall operation of the mobile terminal. According to the present invention, the memory unit 106 stores a program for searching data by using an ontology database. Also, the memory unit 106 manages all the functions and data of the mobile terminal in the ontology database. Herein, the ontology database manages all types of data stored in the mobile terminal (e.g., messages, pictures, memos, memorial days, and music files), in an integrated manner.

The communication unit 108 transmits/receives Radio Frequency (RF) signals inputted/outputted through an antenna. For example, in a transmitting (TX) mode, the communication unit 108 receives a signal from the control unit 100, modulates and up-converts the received signal, and transmits the resulting signal through the antenna. In a receiving (RX) mode, the communication unit 108 receives an RF signal through the antenna, down-converts and demodulates the RF signal, and provides the result signal to the control unit 100.

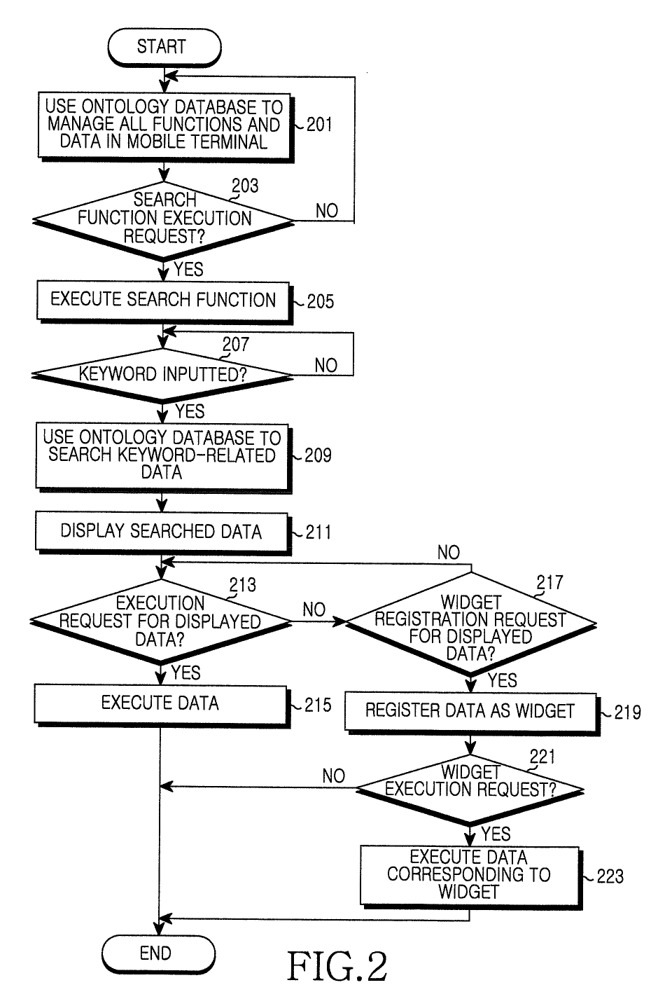

FIG. 2 illustrates a process for searching data in a mobile terminal by using an ontology database according to an embodiment of the present invention.

Referring to FIG. 2, in step 201, the mobile terminal manages its functions and data in an ontology database.

In step 203, the mobile terminal determines whether the execution of a search function is requested. Herein, the search function is to search data stored in the mobile terminal, and the mobile terminal may receive a search function execution request in an idle screen display state or in the state of executing a function or data.

If the execution of a search function is not requested (in step 203), the mobile terminal returns to step 201.

In contrast, if the execution of a search function is requested (in step 203), the mobile terminal returns to step 205. In step 205, the mobile terminal executes the requested search function.

In step 207, the mobile terminal determines whether a keyword is inputted through the search function. Herein, the mobile terminal may provide an auto-complete function to display a prediction text about input character, thereby facilitating the keyword input. That is, the mobile terminal may display a prediction text that begins with the input character when detecting the character input, and may input the keyword by selecting one word of the displayed prediction text.

If a keyword is inputted through the search function (in step 207), the mobile terminal proceeds to step 209. In step 209, the mobile terminal uses the ontology database to search all of the data related to the input keyword regardless of the types of applications or data.

In step 211, the mobile terminal displays the searched data on the screen.

In step 213, the mobile terminal determines whether the execution of one of the displayed data is requested.

If the execution of one of the displayed data is requested within a predetermined time (in step 213), the mobile terminal proceeds to step 215. In step 215, the mobile terminal executes the requested data. Thereafter, the mobile terminal ends the algorithm according to the present invention. Accordingly, the user may access desired data directly without using an application.

In contrast, if the execution of one of the displayed data is not requested (in step 213), the mobile terminal proceeds to step 217. In step 217, the mobile terminal determines whether the widget registration for one or more of the displayed data is requested.

If the widget registration for one or more of the displayed data is not requested (in step 217), the mobile terminal returns to step 213.

In contrast, if the widget registration for one or more of the displayed data is requested within a predetermined time (in step 217), the mobile terminal proceeds to step 219. In step 219, the mobile terminal registers the requested data as a widget. In this manner, when a function and data stored in the mobile terminal is registered as a widget, the user may execute the function or data by one touch.

In step 221, the mobile terminal determines whether the execution of the registered widget is requested.

If the execution of the registered widget is requested (in step 221), the mobile terminal proceeds to step 223. In step 223, the mobile terminal executes data corresponding to the requested widget. Thereafter, the mobile terminal ends the algorithm according to the present invention.

In contrast, if the execution of the registered widget is not requested (in step 221), the mobile terminal ends the algorithm according to the present invention.

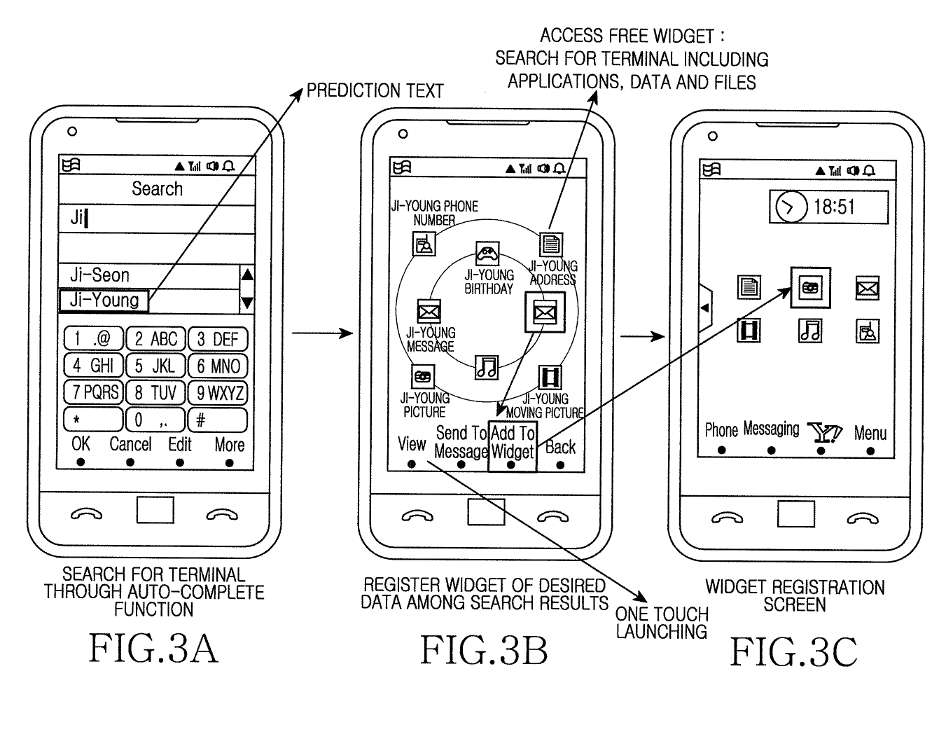

FIGS. 3A-3C illustrate an example of searching data in a mobile terminal by using an ontology database according to an embodiment of the present invention.

Referring to FIGS. 3A-3C, it is assumed that a user attempts to search address information received through a text message from a friend “Ji-Young”. The mobile terminal receives a keyword from the user through a search function (FIG. 3A). The mobile terminal may provide an auto-complete function to display a prediction text for the input character, thereby facilitating the keyword input of the user. For example, the user may decide to search for a keyword “Ji-Young”. When detecting the input of a character ‘Ji’, the mobile terminal may display “Ji-Seon” and “Ji-Young” as a prediction text starting with the letters “Ji”, such that the user may select a keyword “Ji-Young” among the displayed prediction text.

Thereafter, the mobile terminal uses an ontology database to search all of the data related to the keyword regardless of the types of applications or data, and displays the searched data on the screen (FIG. 3B). For example, the mobile terminal may search and display pictures, characters, music files, moving pictures, schedules, phone numbers, and addresses, which are related to the keyword “Ji-Young”, on the screen.

When detecting a widget registration request for one of the displayed data, the mobile terminal registers the requested data as a widget (FIG. 3C). Accordingly, the widget may be included in a widget list displayed on the screen. Because the user attempted to search address information received through a text message from the friend “Ji-Young”, the mobile terminal may receive a request for widget registration of the characters related to the keyword “Ji-Young” among the data searched and displayed on the screen. Accordingly, the mobile terminal may register the characters related to the requested keyword “Ji-Young” as a widget, and may include the widget in a widget list displayed on the screen. In this manner, when the mobile terminal registers the characters related to the keyword “Ji-Young” as a widget and displays the same on the screen, the user may again access the desired data simply through a widget execution request, without entering a text message box to search the text message received from the friend “Ji-Young” or using a search function to again search the text message.

Although not illustrated, when detecting an execution request for one of the displayed data, the mobile terminal directly executes the requested data. Because the user attempted to search address information received through a text message from the friend “Ji-Young”, the mobile terminal may receive a request for the execution of the characters related to the keyword “Ji-Young” among the data searched and displayed on the screen. Accordingly, the mobile terminal may execute the characters related to the requested keyword “Ji-Young”. Accordingly, the user may directly access the desired data.

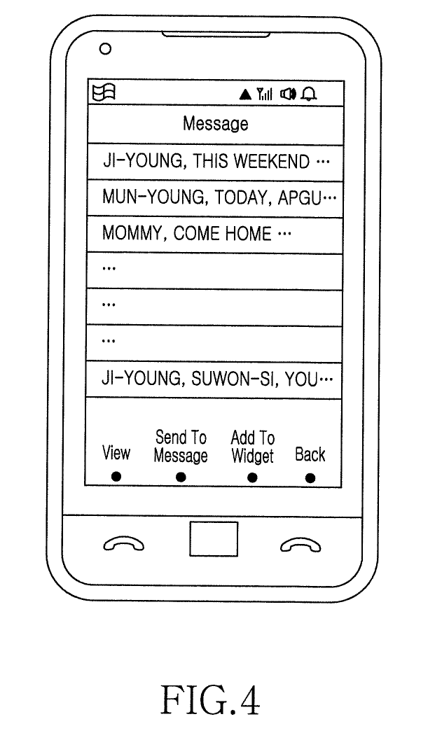

It has been described that the present invention detects a widget registration request for data searched through a search function based on an ontology database and registers the data as a widget. However, the present invention may detect a widget registration request for a function or data while executing the function or data, and register the function or data as a widget. For example, the mobile terminal may select a desired text message from a text message list and register the same as a widget, as illustrated in FIG. 4.

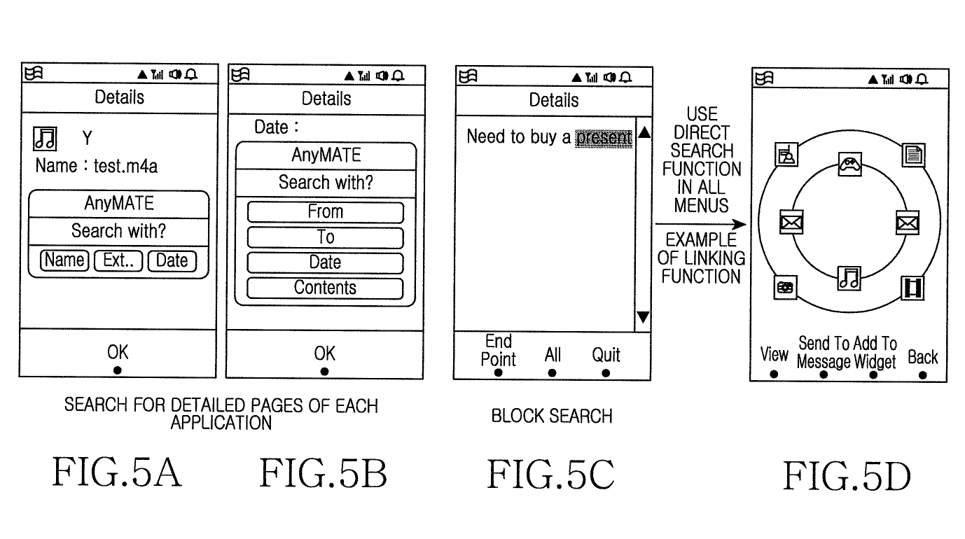

As described above, the mobile terminal may search keyword-related data through a search function in an idle screen display state or while executing a function or data. Accordingly, the mobile terminal may use an ontology database to search other functions or data among all the functions and data and may support a connection to the searched functions and data. For example, as illustrated in FIGS. 5A-5D, while displaying SMS or music files stored (FIGS. 5A, 5B and 5C), the mobile terminal may search other functions or data through a search function and display the searched functions or data on the screen (FIG. 5D), thereby supporting a connection to the searched functions or data. For more rapid search, the mobile terminal may perform a search function within an input search range (e.g., name, extension, date, transmitter, receiver, and content), or may perform a search function for a block of characters (or words or sentences).

As described above, the present invention uses an ontology database to manage all the functions and data in the mobile terminal and search all keyword-related data regardless of the types of applications or data, thereby making it possible to directly access user's desired data without the use of an application. Also, the present invention uses each of data in the ontology database as a widget item to represent functions and data stored in the mobile terminal in the shape of a widget, thereby making it possible to executing a function and data by one touch. Also, the present invention uses the ontology database to search other functions or data in the mobile terminal among all the functions and data and support a connection to the searched functions and data, thereby making it possible to increase the convenience of the user. Accordingly, the user may access and use all the functions and data in the mobile terminal freely and rapidly.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for searching data in a mobile terminal, the method comprising:
managing a function and data of the mobile terminal in an ontology database;
receiving a keyword input through a search function;
searching for one or more data related to the inputted keyword using the ontology database; and
displaying the searched data.

2. The method of claim 1, further comprising, when detecting an execution request for one of the displayed data, executing the requested data.

3. The method of claim 1, further comprising:
when detecting a widget registration request for one or more of the displayed data, registering the requested data as a widget.

4. The method of claim 3, further comprising:
when detecting an execution request for the registered widget, executing data corresponding to the requested widget.

5. The method of claim 3, further comprising:
displaying the registered widget in a widget list.

6. The method of claim 1, further comprising:
receiving a registration request while executing one of a function and data; and
registering the requested one of the function and data as a widget.

7. The method of claim 1, wherein receiving a keyword input through the search function comprises:
receiving at least one character; and
performing an auto-complete function to display a prediction text associated with the at least one character.

8. An apparatus for searching data in a mobile terminal, the apparatus comprising:
a memory unit configured to manage a function and data of the mobile terminal in an ontology database;
an input unit configured to receive a keyword input through a search function;
a control unit configured to search for one or more data related to the inputted keyword using the ontology database; and
a display unit configured to display the searched data.

9. The apparatus of claim 8, wherein the control unit is further configured to execute the requested data when detecting an execution request for one of the displayed data.

10. The apparatus of claim 8, wherein the control unit is further configured to register a requested data as a widget when detecting a widget registration request for one or more of the displayed data.

11. The apparatus of claim 10, wherein the control unit is further configured to execute data corresponding to a requested widget when detecting an execution request for the registered widget.

12. The apparatus of claim 10, wherein the display unit is further configured to display the registered widget in a widget list.

13. The apparatus of claim 8, wherein the control unit is further configured to receive a registration request while executing one of a function and data, and register the requested one of the function and data as a widget.

14. The apparatus of claim 8, wherein the control unit is further configured to:
detect at least one character input through the search function; and
perform an auto-complete function to display a prediction text associated with the at least one character.

15. An apparatus for searching data in a mobile terminal, the apparatus comprising:
a memory unit configured to manage functions and data of the mobile terminal in an ontology database and store a program for searching data using the ontology database; and
a control unit configured to execute the program to search the ontology database for at least one of a function and data related to a keyword received from an input unit and return at least one of a searched function and data.

16. The apparatus of claim 15, wherein the control unit is further configured to execute the requested data when detecting an execution request for one of the searched function and data.

17. The apparatus of claim 15, wherein the control unit is further configured to:
register a requested data as a widget when detecting a widget registration request for one or more of the searched function and data; and
execute at least one of the function and data corresponding to a requested widget when detecting an execution request for the registered widget.

18. The apparatus of claim 15, further comprising a display unit configured to display a user interface for the search function, the at least one searched function and data, and the registered widget in a widget list.

19. The apparatus of claim 15, wherein the control unit is further configured to receive a registration request while executing one of a function and data, and register the requested one of the function and data as a widget.

20. The apparatus of claim 15, wherein the control unit is further configured to execute the program to:
detect at least one character input through the search function; and
perform an auto-complete function to display a prediction text associated with the at least one character.
